(19) United States
(12) Patent Application Publication
(10) Pub. No.: US 2026/0008081 A1
(43) Pub. Date: Jan. 8, 2026

(54) ULTRASONIC GENERATOR

(71) Applicants: NITERRA CO., LTD., Nagoya-shi, Aichi (JP); THE UNIVERSITY OF TOKYO, Tokyo (JP)

(72) Inventors: Satoshi SUZUKI, Nagoya-shi, Aichi (JP); kota YOKOYAMA, Nagoya-shi, Aichi (JP); Ryo SUZUKI, Nagoya-shi, Aichi (JP); Shinsuke ITOH, Nagoya-shi, Aichi (KR); Takashi KASASHIMA, Nagoya-shi, Aichi (JP); Takeshi MORITA, Tokyo (JP); Kyohei YAMADA, Tokyo (JP)

(73) Assignees: NITERRA CO., LTD., Nagoya-shi, Aichi (JP); THE UNIVERSITY OF TOKYO, Tokyo (JP)

(21) Appl. No.: 18/841,529

(22) PCT Filed: Oct. 16, 2023
(86) PCT No.: PCT/JP2023/037355

§ 371 Date: Mar. 19, 2025

(30) Foreign Application Priority Data
Oct. 28, 2022 (JP) 2022-172901
Feb. 28, 2023 (JP) 2023-029211

(51) Int. Cl. B06B 3/00; B06B 1/06

(52) U.S. Cl. CPC B06B 3/00; B06B 1/0651

(57) ABSTRACT

Ultrasonic generator (10) including ultrasonic wave generation source (11), ultrasonic wave converging unit (12), and waveguide (13). Ultrasonic wave converging unit having first reflective surface (16) facing the ultrasonic wave generation source and second reflective surface (17) facing the first reflective surface. The first reflective surface reflecting an ultrasonic wave generated by the ultrasonic wave generation source toward the second reflective surface. The second reflective surface reflecting the ultrasonic wave reflected by the first reflective surface toward the waveguide to introduce the ultrasonic wave into the waveguide. The waveguide being a member separate from the ultrasonic wave converging unit and joined to the ultrasonic wave converging unit in joining section (22). The joining section being disposed in a region on an inner peripheral side of a region (R) obtained by extending outer peripheral edge (11B) of the ultrasonic wave generation source in a facing direction.

### TECHNICAL FIELD

The present invention relates to an ultrasonic generator.

### BACKGROUND ART

Ultrasonic generators for various applications, such as diagnosis and treatment, have been known. For example, Patent Document 1 below describes an ultrasonic generator including an ultrasonic wave generation source that generates an ultrasonic wave, an ultrasonic wave converging unit that converges the ultrasonic wave generated by the ultrasonic wave generation source, and a waveguide that transmits the ultrasonic wave converged by the ultrasonic wave converging unit. The ultrasonic wave generated by the ultrasonic wave generation source is transmitted to a front end of the waveguide.

### CITATION LIST

### Patent Literature

PTL 1: International Publication No. 2006/028249

### SUMMARY OF INVENTION

### Technical Problem

The above-described ultrasonic generator desirably includes the waveguide whose length, end shape, material, etc., are optimized for the application of the ultrasonic generator.

The present invention has been made in light of the above-described circumstances, and its object is to provide an ultrasonic generator in which an optimum waveguide for the application can be readily used.

### Solution to Problem

The ultrasonic generator according to the present invention includes an ultrasonic wave generation source that generates an ultrasonic wave; an ultrasonic wave converging unit that converges the ultrasonic wave generated by the ultrasonic wave generation source; and a waveguide that transmits the ultrasonic wave converged by the ultrasonic wave converging unit. The ultrasonic wave converging unit has a first reflective surface facing the ultrasonic wave generation source and a second reflective surface facing the first reflective surface. The first reflective surface is a curved surface that is convex in a direction away from the ultrasonic wave generation source and reflects the ultrasonic wave generated by the ultrasonic wave generation source toward the second reflective surface. The second reflective surface reflects the ultrasonic wave reflected by the first reflective surface toward the waveguide so that the ultrasonic wave is introduced into the waveguide. The waveguide is a member separate from the ultrasonic wave converging unit and joined to the ultrasonic wave converging unit in a joining section. The joining section is disposed in a region on an inner peripheral side of a region obtained by extending an outer peripheral edge of the ultrasonic wave generation source in a facing direction in which the ultrasonic wave generation source and the first reflective surface face each other.

### Advantageous Effects of Invention

According to the present invention, since the waveguide is a member separate from the ultrasonic wave converging unit, the waveguide can be changed in accordance with the application while using the ultrasonic wave generation source and the ultrasonic wave converging unit in common. Therefore, an optimum waveguide for the application can be readily used.

### BRIEF DESCRIPTION OF DRAWINGS

FIG. 1 is a diagram of the basic structure of an ultrasonic generator, illustrating the manner in which an ultrasonic wave generated by an ultrasonic wave generation source travels straight toward a first reflective surface.

FIG. 2 is another diagram of the basic structure of the ultrasonic generator, illustrating the manner in which the ultrasonic wave reflected by the first reflective surface converges toward a focal point.

FIG. 3 is a schematic sectional view of an ultrasonic generator according to a first embodiment.

FIG. 4 is a bottom view of the ultrasonic generator.

FIG. 5 is a schematic sectional view of an ultrasonic generator according to a second embodiment.

FIG. 6 is a schematic sectional view of an ultrasonic generator according to a third embodiment.

FIG. 7 is a schematic sectional view of an ultrasonic generator according to a fourth embodiment.

FIG. 8 is a schematic sectional view of an ultrasonic generator according to a fifth embodiment.

FIG. 9 is a schematic sectional view of an ultrasonic generator according to a sixth embodiment.

FIG. 10 is a schematic sectional view of an ultrasonic generator according to a seventh embodiment.

FIG. 11 is a schematic sectional view of an ultrasonic generator according to an eighth embodiment.

FIG. 12 is a schematic sectional view of an ultrasonic generator according to another embodiment (1).

FIG. 13 is a schematic sectional view of an ultrasonic generator according to another embodiment (2).

FIG. 14 is a schematic sectional view of an ultrasonic generator according to another embodiment (3).

FIG. 15 is a schematic sectional view of an ultrasonic generator according to another embodiment (4).

FIG. 16 is a schematic sectional view of an ultrasonic generator according to another embodiment (5).

FIG. 17 is a schematic sectional view of an ultrasonic generator according to another embodiment (6).

### DESCRIPTION OF EMBODIMENTS

Preferred embodiments of the present invention will now be described.

(1) An ultrasonic generator according to the present invention includes an ultrasonic wave generation source that generates an ultrasonic wave; an ultrasonic wave converging unit that converges the ultrasonic wave generated by the ultrasonic wave generation source; and a waveguide that transmits the ultrasonic wave converged by the ultrasonic wave converging unit. The ultrasonic wave converging unit has a first reflective surface facing the ultrasonic wave generation source and a second reflective surface facing the first reflective surface. The first reflective surface is a curved surface that is convex in a direction away from the ultrasonic wave generation source and reflects the ultrasonic wave generated by the ultrasonic wave generation source toward the second reflective surface. The second reflective surface reflects the ultrasonic wave reflected by the first reflective surface toward the waveguide so that the ultrasonic wave is introduced into the waveguide. The waveguide is a member separate from the ultrasonic wave converging unit and joined to the ultrasonic wave converging unit in a joining section. The joining section is disposed in a region on an inner peripheral side of a region obtained by extending an outer peripheral edge of the ultrasonic wave generation source in a facing direction in which the ultrasonic wave generation source and the first reflective surface face each other. According to this structure, since the waveguide is a member separate from the ultrasonic wave converging unit, the waveguide can be changed in accordance with the application while using the ultrasonic wave generation source and the ultrasonic wave converging unit in common. Therefore, the optimum waveguide for the application can be readily used.

(2) In the ultrasonic generator according to (1), the second reflective surface may be a curved surface that is convex in a direction away from the first reflective surface. The ultrasonic wave generation source may be shaped to surround a periphery of the second reflective surface in radial directions orthogonal to the facing direction. The joining section may be disposed in a region on an inner peripheral side of a first region obtained by extending an inner peripheral edge of the ultrasonic wave generation source in the facing direction. According to this structure, since the joining section in which the waveguide and the ultrasonic wave converging unit are joined is disposed in the region on an inner peripheral side of the first region, the joining section does not overlap the propagation region through which the ultrasonic wave generated by the ultrasonic wave generation source travels toward the first reflective surface. Therefore, the joining section does not obstruct the propagation of the ultrasonic wave generated by the ultrasonic wave generation source.

(3) In the ultrasonic generator according to (1) or (2), the waveguide may include an introduction portion, and the joining section may include a recess that is recessed from the first reflective surface toward the second reflective surface. When a first imaginary line is an intersecting line between the first region and the first reflective surface and when a second region is a region extending from the first imaginary line to a focal point of the first reflective surface, the recess may be disposed in a region on an inner peripheral side of the second region. The introduction portion may be inserted in the recess. According to this structure, the waveguide and the ultrasonic wave converging unit can be joined together without using a fastening part or the like. Therefore, the number of parts can be reduced compared to the case where the fastening part or the like is used. Since the recess is disposed in the region on an inner peripheral side of the second region, the recess does not overlap the propagation region through which the ultrasonic wave converges from the first reflective surface toward the focal point. Therefore, the recess does not obstruct the propagation of the ultrasonic wave that converges from the first reflective surface toward the focal point.

(4) In the ultrasonic generator according to (3), an outer peripheral surface of the introduction portion and an inner peripheral surface of the recess may each have a helical groove, and the introduction portion may be fixed to the recess by screwing. According to this structure, the waveguide and the ultrasonic wave converging unit can be joined together without performing resistance welding or using an adhesive.

(5) In the ultrasonic generator according to (1) or (2), the ultrasonic wave converging unit may include a projecting portion that projects from the first reflective surface in a direction away from the second reflective surface. The waveguide may be joined to a projecting end of the projecting portion. According to this structure, a surface at which the waveguide is joined to the ultrasonic wave converging unit can be easily formed in a flat shape, so that the ultrasonic characteristics can be improved.

(6) In the ultrasonic generator according to (5), the waveguide may include an introduction portion, and the ultrasonic generator may further include a tubular holding member that extends from an outer peripheral surface of the introduction portion to an outer peripheral surface of the projecting portion in a state where the waveguide and the projecting end of the projecting portion abut against each other. According to this structure, the joined state of the projecting portion and the introduction portion can be retained by the holding member. Therefore, the joining strength between the waveguide and the ultrasonic wave converging unit can be increased.

(7) In the ultrasonic generator according to (5), the waveguide may include a tubular portion projecting from an outer peripheral edge of the waveguide toward the first reflective surface, and the tubular portion may be fitted to an outer periphery of the projecting portion. According to this structure, by fitting the tubular portion to the outer periphery of the projecting portion, the joined state of the projecting portion and the waveguide can be retained. Therefore, the joining strength between the waveguide and the ultrasonic wave converging unit can be increased without using another part.

(8) In the ultrasonic generator according to (1) or (2), the waveguide may be joined to the first reflective surface. According to this structure, the waveguide and the ultrasonic wave converging unit can be joined together without forming a recess or a projecting portion on the ultrasonic wave converging unit.

(9) In the ultrasonic generator according to any one of (1) to (8), the ultrasonic wave converging unit may have a joining surface that is joined to the waveguide. A space between the waveguide and the joining surface may be filled with a medium that transmits the ultrasonic wave. According to this structure, a gap is less likely to be formed between the waveguide and the joining surface. Therefore, it is possible to prevent the ultrasonic wave from changing due to a gap between the waveguide and the joining surface.

(10) In the ultrasonic generator according to any one of (1) to (9), the waveguide and the ultrasonic wave converging unit may respectively have an introduction surface and a joining surface that face each other and are joined together. The introduction surface and the joining surface may be flat surfaces. According to this structure, the ultrasonic characteristics can be improved.

(11) The ultrasonic generator according to any one of (1) to (10) may further include a fixing member that fixes the waveguide. According to this structure, the joined state of the waveguide and the ultrasonic wave converging unit can be retained by the fixing member. Therefore, the joining strength between the waveguide and the ultrasonic wave converging unit can be increased.

### First Embodiment

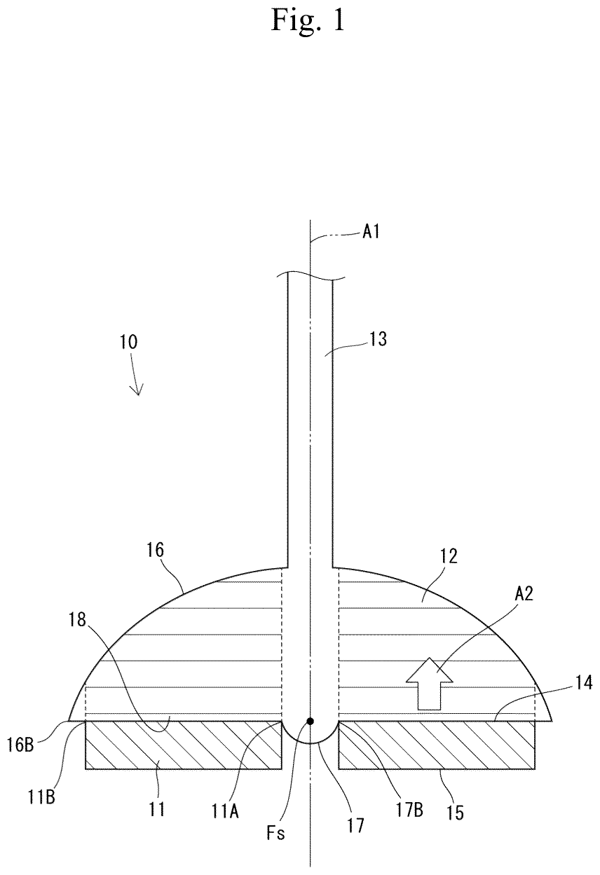

A first embodiment of the present invention will now be described in detail with reference to FIGS. 1 to 4. An ultrasonic generator 10 according to the present embodiment is used in, for example, an ultrasonic diagnosis device, an ultrasonic treatment device, or a cavitation generator.

The basic structure of the ultrasonic generator 10 will now be described. As illustrated in FIG. 1, the ultrasonic generator 10 includes an ultrasonic wave generation source 11, an ultrasonic wave converging unit 12, and a waveguide 13. The ultrasonic wave generation source 11 generates an ultrasonic wave. The ultrasonic wave converging unit 12 converges the ultrasonic wave generated by the ultrasonic wave generation source 11. The waveguide 13 transmits the ultrasonic wave converged by the ultrasonic wave converging unit 12. The ultrasonic wave transmitted by the waveguide 13 is radiated to an object. There is no particular limitation regarding the object, and the object may be inside a living body, for example. The ultrasonic wave radiated to the object is reflected by the object and returns to the waveguide 13 as an ultrasonic wave carrying image information of the object. The ultrasonic wave carrying the image information of the object passes through the waveguide 13 and the ultrasonic wave converging unit 12 and returns to the ultrasonic wave generation source 11. An electric signal corresponding to the ultrasonic wave carrying the image information is received by a signal transmitting/receiving circuit, and the image information included in the received signal is displayed on a signal display device. As a technology for displaying an image based on ultrasonic wave including image information, a known technique used in an ultrasonic diagnosis device and the like can be employed.

The ultrasonic wave generation source 11 is, for example, a piezo-electric element. The ultrasonic wave generation source 11 has a plate shape with a predetermined thickness. The ultrasonic wave generation source 11 has a first principal surface 14 and a second principal surface 15 at a side opposite to the side of the first principal surface 14. The first principal surface 14 and the second principal surface 15 are provided with electrodes (not illustrated). The first principal surface 14 is bonded to the ultrasonic wave converging unit 12 with an adhesive (not illustrated). In an up-down direction, the first principal surface 14 is disposed at the same position as an outer peripheral edge 17B of a second reflective surface 17.

The ultrasonic wave generation source 11 generates an ultrasonic wave when an electric signal is applied thereto from a signal transmitting/receiving circuit (not illustrated). The ultrasonic wave generated by the ultrasonic wave generation source 11 is a plane wave that travels straight in the direction of arrow A2 shown in FIG. 1. Arrow A2 shows the direction in which the ultrasonic wave generated by the ultrasonic wave generation source 11 travels. Arrow A2 is parallel to an axis A1. The ultrasonic wave generation source 11 generates an ultrasonic wave with a frequency of, for example, 30 kHz or more. In the following description of each structural component, the direction shown by arrow A2 in FIG. 1 will be referred to as an upper side, and the direction opposite thereto will be referred to as a lower side.

The ultrasonic wave converging unit 12 has a first reflective surface 16 and the second reflective surface 17. The first reflective surface 16 faces the ultrasonic wave generation source 11. A facing direction in which the first reflective surface 16 and the ultrasonic wave generation source 11 face each other is parallel to the direction in which the axis A1 extends. When viewed from the outside of the ultrasonic wave converging unit 12, the first reflective surface 16 is a parabolic surface that is convex upward (away from the ultrasonic wave generation source 11). When viewed from the inside of the ultrasonic wave converging unit 12, the first reflective surface 16 is concave. A central portion of the first reflective surface 16 is disposed above an outer peripheral edge 16B of the first reflective surface 16. The first reflective surface 16 is a paraboloid of revolution around the axis A1.

The second reflective surface 17 is disposed to face the first reflective surface 16. When viewed from the outside of the ultrasonic wave converging unit 12, the second reflective surface 17 is a curved surface (for example, parabolic surface) that is convex downward (away from the first reflective surface 16). When viewed from the inside of the ultrasonic wave converging unit 12, the second reflective surface 17 is concave. A central portion of the second reflective surface 17 is disposed below the outer peripheral edge 17B of the second reflective surface 17. The second reflective surface 17 is a paraboloid of revolution around the axis A1.

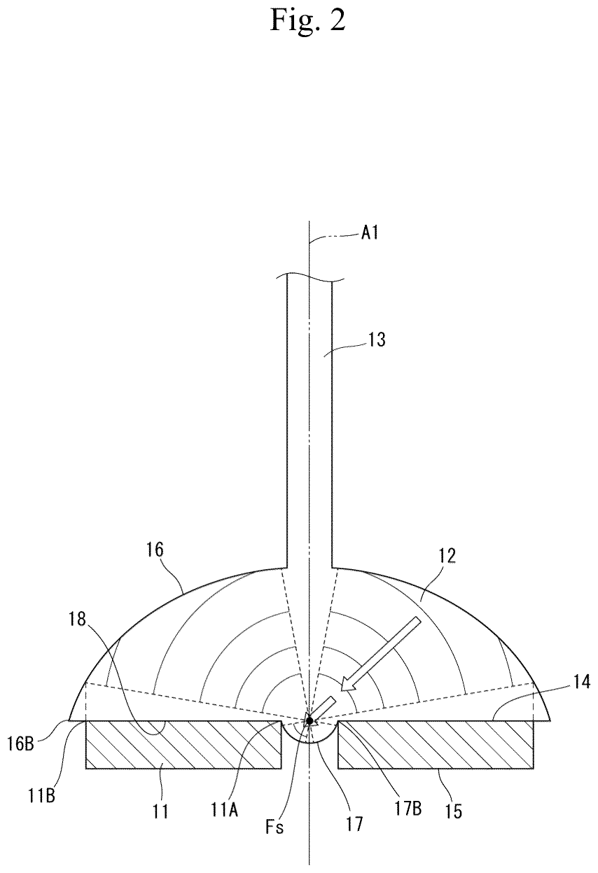

As illustrated in FIG. 2, the ultrasonic wave generated by the ultrasonic wave generation source 11 is reflected by the first reflective surface 16 and converges toward a focal point Fs of the first reflective surface 16. The ultrasonic wave that has passed through the focal point Fs is reflected by the second reflective surface 17 and converges toward a focal point Fs of the second reflective surface 17. The focal point Fs of the second reflective surface 17 coincides with the focal point Fs of the first reflective surface 16. The ultrasonic wave that has been reflected by the second reflective surface 17 and passed through the focal point Fs is introduced into the waveguide 13 as a plane wave. The focal point Fs is on the axis A1.

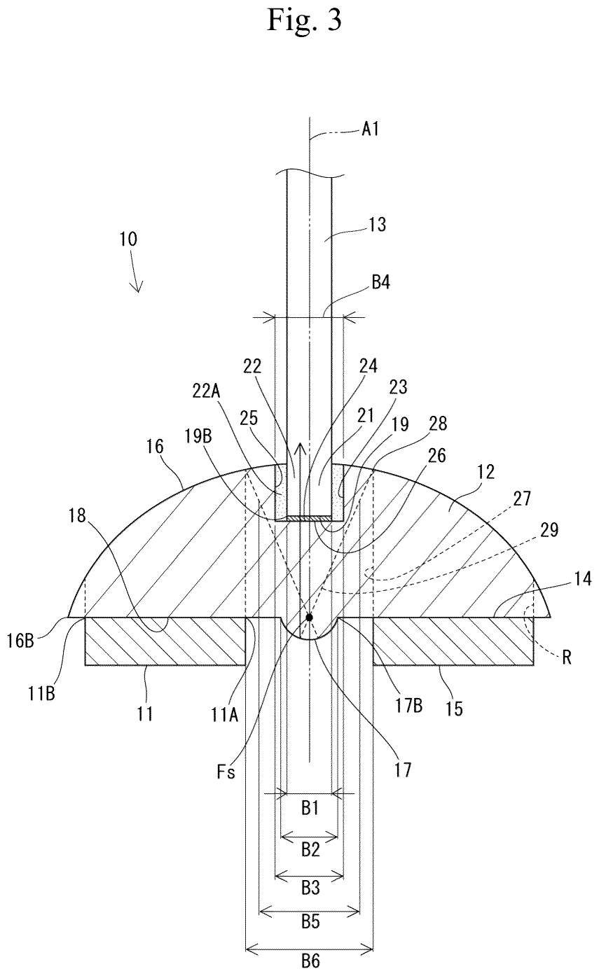

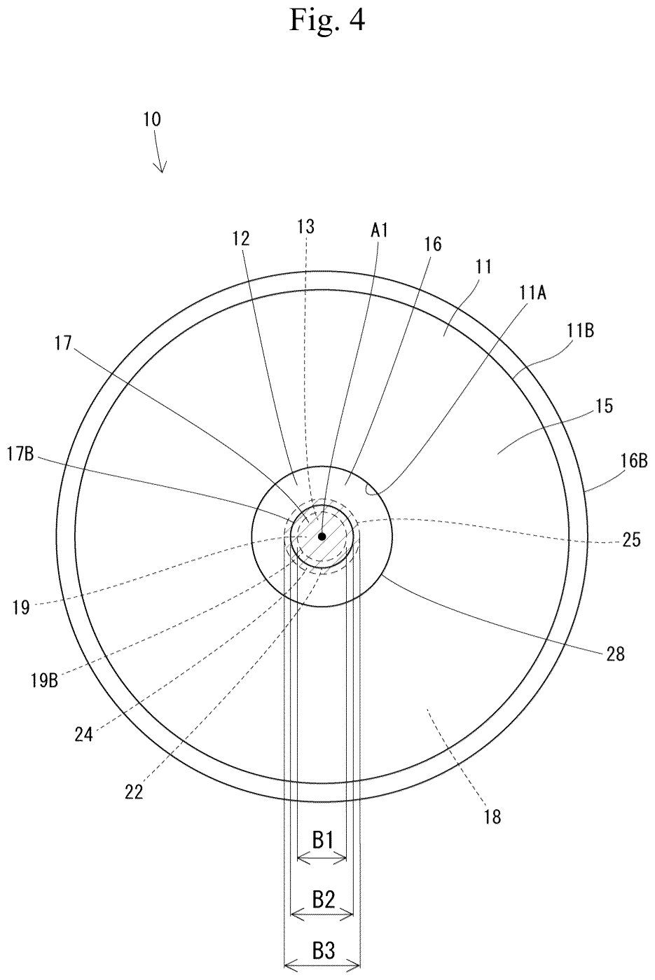

The ultrasonic generator 10 will now be described in detail. As illustrated in FIGS. 3 and 4, the ultrasonic wave generation source 11 surrounds the periphery of the second reflective surface 17. The ultrasonic wave generation source 11 has an annular shape with the axis A1 at the center. An inner peripheral edge 11A of the ultrasonic wave generation source 11 is separated outward from the outer peripheral edge 17B of the second reflective surface 17 in radial directions orthogonal to the axis A1. An outer peripheral edge 11B of the ultrasonic wave generation source 11 is separated inward from the outer peripheral edge 16B of the first reflective surface 16 in the radial directions orthogonal to the axis A1. The outer peripheral edge 16B of the first reflective surface 16 and the outer peripheral edge 17B of the second reflective surface 17, when viewed from below, are concentric circles having the axis A1 at the center. As illustrated in FIG. 3, the inner peripheral edge 11A and the outer peripheral edge 11B of the ultrasonic wave generation source 11 are an inner peripheral edge and an outer peripheral edge, of the first principal surface 14, respectively. The outer peripheral edge 11B of the ultrasonic wave generation source 11 defines an outer peripheral edge of a contact surface between the ultrasonic wave generation source 11 and the ultrasonic wave converging unit 12.

The ultrasonic wave converging unit 12 is composed of, for example, a solid body made of metal (for example, duralumin). The ultrasonic wave converging unit 12 has an adhesion surface 18 that adheres to the ultrasonic wave generation source 11. The adhesion surface 18 extends outward in the radial directions orthogonal to the axis A1 from the outer peripheral edge 17B of the second reflective surface 17 up to the outer peripheral edge 16B of the first reflective surface 16. The adhesion surface 18 is a flat surface orthogonal to the axis A1. The adhesion surface 18 has an annular shape with the axis A1 at the center, and surrounds the periphery of the second reflective surface 17.

As illustrated in FIG. 3, the waveguide 13 is a member separate from the ultrasonic wave converging unit 12. The waveguide 13 has a solid columnar shape. The waveguide 13 extends upward along the axis A1 from the center of the first reflective surface 16. The lower end face of the waveguide 13 is an introduction surface 19. The ultrasonic wave is introduced into the waveguide 13 through the introduction surface 19. The introduction surface 19 is a flat surface orthogonal to the axis A1.

As illustrated in FIG. 4, the introduction surface 19 has a circular shape with the axis A1 at the center. A diameter B1 of the introduction surface 19 in a direction orthogonal to the axis A1 is less than a diameter B2 of the second reflective surface 17 in a direction orthogonal to the axis A1. In a direction orthogonal to the axis A1, an outer peripheral edge 19B of the introduction surface 19 is positioned inside the outer peripheral edge 17B of the second reflective surface 17.

As illustrated in FIG. 3, the waveguide 13 is joined to the ultrasonic wave converging unit 12 in a joining section 22. The joining section 22 is disposed in a region on an inner peripheral side of a region R obtained by extending the outer peripheral edge 11B of the ultrasonic wave generation source 11 in the facing direction in which the ultrasonic wave generation source 11 and the first reflective surface 16 face each other. The region R is constituted by all straight lines that pass through the outer peripheral edge 11B of the ultrasonic wave generation source 11 and are parallel to the axis A1. The region R has a cylindrical shape with the axis A1 at the center.

The joining section 22 includes a recess 23 recessed downward (toward the second reflective surface 17) from the first reflective surface 16. The recess 23 has a joining surface 24 and an inner peripheral surface 25. The joining surface 24 is the bottom surface of the recess 23. The joining surface 24 is a flat surface orthogonal to the axis A1.

As illustrated in FIG. 4, the joining surface 24 has a circular shape with the axis A1 at the center. A diameter B3 of the joining surface 24 in a direction orthogonal to the axis A1 is greater than the diameter B1 of the introduction surface 19 and the diameter B2 of the second reflective surface 17. The inner peripheral surface 25 has a cylindrical shape with the axis A1 at the center. A diameter B4 of the inner peripheral surface 25 in a direction orthogonal to the axis A1 is less than a diameter B6 of a first region 27 in a direction orthogonal to the axis A1. The diameter B4 of the inner peripheral surface 25 is equal to the diameter B3 of the joining surface 24. The diameter B4 of the inner peripheral surface 25 is constant in the up-down direction.

As illustrated in FIG. 3, a lower end portion of the waveguide 13 is an introduction portion 21. The introduction portion 21 has the introduction surface 19. The introduction portion 21 is inserted in the recess 23. The introduction portion 21 is fixed to the recess 23 with an adhesive 22A. The adhesive 22A is made of a material that does not easily soften or melt due to heat. The introduction surface 19 and the joining surface 24 face each other in the joining section 22. The space between the introduction surface 19 and the joining surface 24 is filled with a medium 26 that transmits the ultrasonic wave. This can prevent a hollow space from being formed between the introduction surface 19 and the joining surface 24. The medium 26 that transmits the ultrasonic wave may be a part of the adhesive 22A.

The location of the joining section 22 will now be described. As illustrated in FIG. 3, the joining section 22 is disposed such that the joining section 22 does not overlap the propagation region of the ultrasonic wave. More specifically, the joining section 22 does not overlap the propagation region through which the ultrasonic wave generated by the ultrasonic wave generation source 11 travels toward the first reflective surface 16 and the propagation region through which the ultrasonic wave converges from the first reflective surface 16 toward the focal point Fs.

The propagation region through which the ultrasonic wave generated by the ultrasonic wave generation source 11 travels toward the first reflective surface 16 is a region outside the first region 27. The first region 27 is a region obtained by extending the inner peripheral edge 11A of the ultrasonic wave generation source 11 in the facing direction in which the ultrasonic wave generation source 11 and the first reflective surface 16 face each other. The first region 27 is constituted by all straight lines that pass through the inner peripheral edge 11A of the ultrasonic wave generation source 11 and are parallel to the axis A1. The first region 27 has a cylindrical shape with the axis A1 at the center.

The joining section 22 is disposed inside the first region 27. The entirety of the joining section 22 is separated inward from the first region 27.

The propagation region through which the ultrasonic wave converges from the first reflective surface 16 toward the focal point Fs is a region outside a second region 29. The second region 29 is a region that extends from a first imaginary line 28 to the focal point Fs of the first reflective surface 16. The second region 29 is constituted by line segments that pass through all points on the first imaginary line 28 and the focal point Fs. The first imaginary line 28 is an intersecting line between the first region 27 and the first reflective surface 16. The first imaginary line 28 is a projection of the inner peripheral edge 11A of the ultrasonic wave generation source 11 on the first reflective surface 16 in a direction parallel to the axis A1. The first imaginary line 28 has a circular shape with the axis A1 at the center. The second region 29 has the shape of a right circular cone having the axis A1 at the center. A diameter B5 of the second region 29 in a direction orthogonal to the axis A1 gradually increases from the lower side to the upper side.

The recess 23 is disposed in an upper part of a region on an inner peripheral side of the second region 29. The entirety of the recess 23 is separated from the second region 29. The diameter B4 of the inner peripheral surface 25 of the recess 23 is at least less than the diameter B5 of the second region 29 above the joining surface 24.

The first embodiment having the above-described structure has the advantages described below. The ultrasonic generator 10 according to the first embodiment includes the ultrasonic wave generation source 11, the ultrasonic wave converging unit 12, and the waveguide 13. The ultrasonic wave generation source 11 generates an ultrasonic wave. The ultrasonic wave converging unit 12 converges the ultrasonic wave generated by the ultrasonic wave generation source 11. The waveguide 13 transmits the ultrasonic wave converged by the ultrasonic wave converging unit 12. The ultrasonic wave converging unit 12 has the first reflective surface 16 that is parabolic and the second reflective surface 17 that is also parabolic. The first reflective surface 16 faces the ultrasonic wave generation source 11. The second reflective surface 17 faces the first reflective surface 16. The first reflective surface 16 reflects the ultrasonic wave generated by the ultrasonic wave generation source 11 toward the second reflective surface 17. The second reflective surface 17 reflects the ultrasonic wave reflected by the first reflective surface 16 toward the waveguide 13 so that the ultrasonic wave is introduced into the waveguide 13. The ultrasonic wave generation source 11 surrounds the periphery of the second reflective surface 17 in radial directions orthogonal to the facing direction in which the ultrasonic wave generation source 11 and the first reflective surface 16 face each other. The waveguide 13 is a member separate from the ultrasonic wave converging unit 12, and is joined to the ultrasonic wave converging unit 12 in the joining section 22. The joining section 22 is disposed in the region on an inner peripheral side of the first region 27 obtained by extending the inner peripheral edge 11A of the ultrasonic wave generation source 11 in the facing direction.

According to this structure, since the waveguide 13 is a member separate from the ultrasonic wave converging unit 12, the waveguide 13 can be changed in accordance with the application while using the ultrasonic wave generation source 11 and the ultrasonic wave converging unit 12 in common. Therefore, the optimum waveguide 13 for the application can be readily used. Since the joining section 22 in which the waveguide 13 and the ultrasonic wave converging unit 12 are joined is disposed in the region on an inner peripheral side of the first region 27, the joining section 22 does not overlap the propagation region through which the ultrasonic wave generated by the ultrasonic wave generation source 11 travels toward the first reflective surface 16. Therefore, the joining section 22 does not obstruct the propagation of the ultrasonic wave generated by the ultrasonic wave generation source 11.

The waveguide 13 includes the introduction portion 21. The joining section 22 includes the recess 23 recessed from the first reflective surface 16 toward the second reflective surface 17. When the first imaginary line 28 is the intersecting line between the first region 27 and the first reflective surface 16 and when the second region 29 is the region extending from the first imaginary line 28 to the focal point Fs of the first reflective surface 16, the recess 23 is disposed in a region on an inner peripheral side of the second region 29. The introduction portion 21 is inserted in the recess 23. According to this structure, the waveguide 13 and the ultrasonic wave converging unit 12 can be joined together without using a fastening part or the like. Therefore, the number of parts can be reduced compared to the case where the fastening part or the like is used. Since the recess 23 is disposed in the region on an inner peripheral side of the second region 29, the recess 23 does not overlap the propagation region through which the ultrasonic wave converges from the first reflective surface 16 toward the focal point Fs. Therefore, the recess 23 does not obstruct the propagation of the ultrasonic wave that converges from the first reflective surface 16 toward the focal point Fs.

In addition, the ultrasonic wave converging unit 12 has the joining surface 24 which is joined to the waveguide 13. The space between the waveguide 13 and the joining surface 24 is filled with the medium 26 that transmits the ultrasonic wave. According to this structure, a gap is less likely to be formed between the waveguide 13 and the joining surface 24. Therefore, it is possible to prevent the ultrasonic wave from changing due to a gap between the waveguide 13 and the joining surface 24.

The waveguide 13 and the ultrasonic wave converging unit 12 are joined together such that the introduction surface 19 of the waveguide 13 and the joining surface 24 of the ultrasonic wave converging unit 12 face each other. The introduction surface 19 and the joining surface 24 are flat surfaces. According to this structure, the ultrasonic characteristics can be improved.

### Second Embodiment

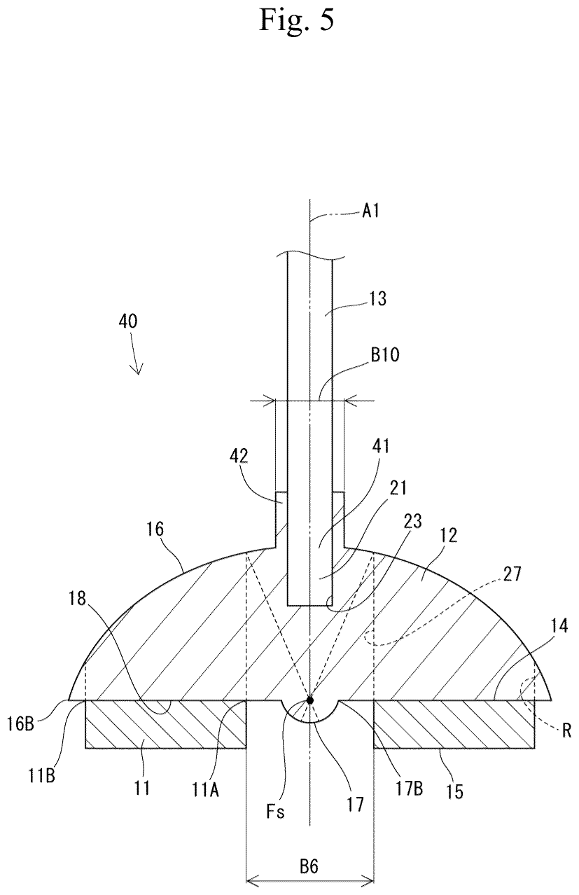

An ultrasonic generator 40 according to a second embodiment of the present invention will now be described with reference to FIG. 5. The ultrasonic generator 40 according to the present embodiment differs from the ultrasonic generator of the first embodiment in that a joining section 41 includes a tubular portion 42. Structures similar to those in the first embodiment are denoted by the same reference signs, and description thereof is omitted.

As in the first embodiment, the ultrasonic generator 40 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the first embodiment, the waveguide 13 is a member separate from the ultrasonic wave converging unit 12, and is joined to the ultrasonic wave converging unit 12 in the joining section 41.

As in the first embodiment, the joining section 41 includes a recess 23 recessed downward from the first reflective surface 16, and the introduction portion 21 is inserted in the recess 23. The tubular portion 42 projects upward from the upper end of the recess 23. The tubular portion 42 has a cylindrical shape with the axis A1 at the center. The tubular portion 42 is fitted to the outer periphery of the waveguide 13. An outer diameter B10 of the tubular portion 42 in a direction orthogonal to the axis A1 is constant in the up-down direction.

As in the first embodiment, the joining section 41 is disposed in the region on an inner peripheral side of the first region 27. The outer diameter B10 of the tubular portion 42 is less than the diameter B6 of the first region 27. The entirety of the joining section 41 is separated inward from the first region 27.

As described above, in the present embodiment, as in the first embodiment, the waveguide 13 is a member separate from the ultrasonic wave converging unit 12, and is joined to the ultrasonic wave converging unit 12 in the joining section 41. Therefore, the waveguide 13 can be changed in accordance with the application while using the ultrasonic wave generation source 11 and the ultrasonic wave converging unit 12 in common. In addition, as in the first embodiment, the joining section 41 in which the waveguide 13 and the ultrasonic wave converging unit 12 are joined does not overlap the propagation region through which the ultrasonic wave generated by the ultrasonic wave generation source 11 travels toward the first reflective surface 16. Therefore, the joining section 41 can be prevented from obstructing the propagation of the ultrasonic wave generated by the ultrasonic wave generation source 11.

In addition, the recess 23 is provided with the tubular portion 42 projecting upward from the upper edge of the recess 23, and the tubular portion 42 is fitted to the outer periphery of the waveguide 13. According to this structure, by fitting the tubular portion 42 to the outer periphery of the waveguide 13, the joined state of the recess 23 and the introduction portion 21 can be retained. Therefore, the joining strength between the waveguide 13 and the ultrasonic wave converging unit 12 can be increased without using another part.

### Third Embodiment

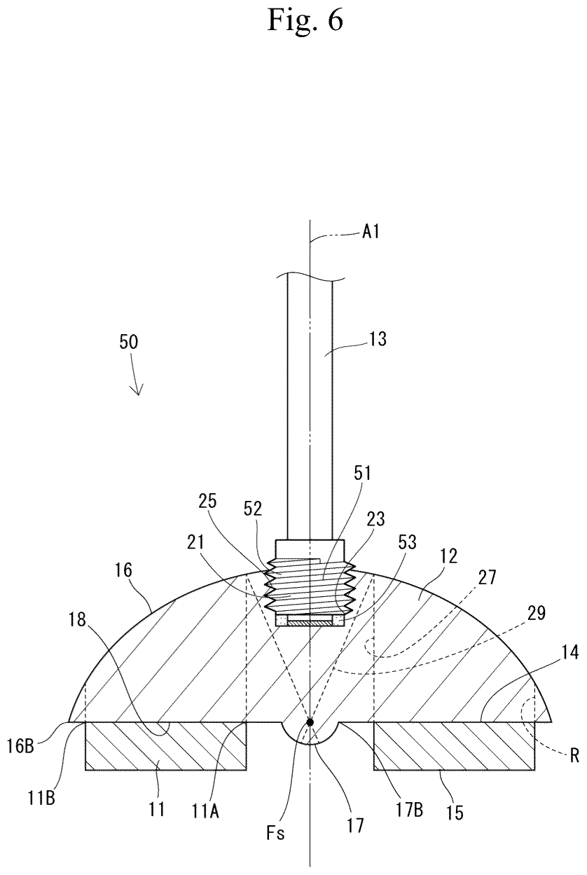

An ultrasonic generator 50 according to a third embodiment of the present invention will now be described with reference to FIG. 6. The ultrasonic generator 50 according to the present embodiment differs from the ultrasonic generator of the first embodiment in that a joining section 51 includes a screwing structure 52. Structures similar to those in the first embodiment are denoted by the same reference signs, and description thereof is omitted.

As in the first embodiment, the ultrasonic generator 50 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the first embodiment, the waveguide 13 is a member separate from the ultrasonic wave converging unit 12, and is joined to the ultrasonic wave converging unit 12 in the joining section 51.

As in the first embodiment, the joining section 51 includes a recess 23 recessed downward from the first reflective surface 16, and the introduction portion 21 is inserted in the recess 23. The outer peripheral surface of the introduction portion 21 and the inner peripheral surface 25 of the recess 23 have helical grooves. The introduction portion 21 has an external thread, and the recess 23 has an internal thread. The introduction portion 21 is fixed to the recess 23 by the screwing structure 52. The space between the introduction portion 21 and the recess 23 is filled with a medium 53 that transmits the ultrasonic wave. The medium 53 that transmits the ultrasonic wave may be various types of materials, such as liquid, gel, or solid. As in the first embodiment, the joining section 51 is disposed in the region on an inner peripheral side of the first region 27.

As described above, in the present embodiment, as in the first embodiment, the waveguide 13 is a member separate from the ultrasonic wave converging unit 12, and is joined to the ultrasonic wave converging unit 12 in the joining section 51. Therefore, the waveguide 13 can be changed in accordance with the application while using the ultrasonic wave generation source 11 and the ultrasonic wave converging unit 12 in common. In addition, as in the first embodiment, the joining section 51 in which the waveguide 13 and the ultrasonic wave converging unit 12 are joined does not overlap the propagation region through which the ultrasonic wave generated by the ultrasonic wave generation source 11 travels toward the first reflective surface 16. Therefore, the joining section 51 can be prevented from obstructing the propagation of the ultrasonic wave generated by the ultrasonic wave generation source 11.

In addition, the outer peripheral surface of the introduction portion 21 and the inner peripheral surface 25 of the recess 23 have helical grooves, and the introduction portion 21 is fixed to the recess 23 by screwing. According to this structure, the waveguide 13 and the ultrasonic wave converging unit 12 can be joined together without applying resistance welding or an adhesive.

### Fourth Embodiment

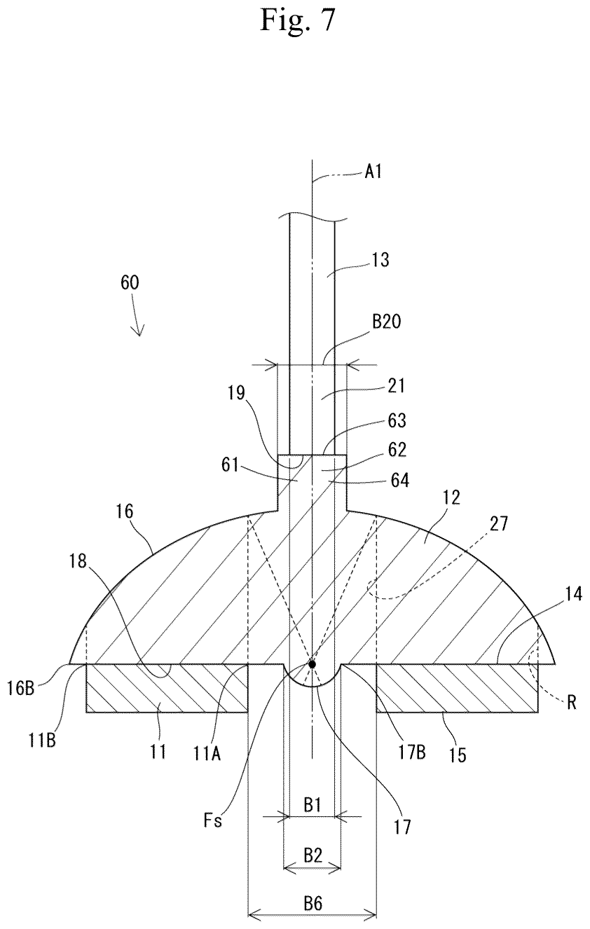

An ultrasonic generator 60 according to a fourth embodiment of the present invention will now be described with reference to FIG. 7. The ultrasonic generator 60 according to the present embodiment differs from the ultrasonic generator of the first embodiment in that a joining section 61 includes a projecting portion 62. Structures similar to those in the first embodiment are denoted by the same reference signs, and description thereof is omitted.

As in the first embodiment, the ultrasonic generator 60 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the first embodiment, the waveguide 13 is a member separate from the ultrasonic wave converging unit 12, and is joined to the ultrasonic wave converging unit 12 in the joining section 61.

The joining section 61 includes the projecting portion 62 that projects upward (away from the second reflective surface 17) from the first reflective surface 16. The projecting portion 62 has a joining surface 63 and an outer peripheral surface 64. The joining surface 63 is a projecting end surface of the projecting portion 62. The joining surface 63 is a flat surface orthogonal to the axis A1. The joining surface 63 has a circular shape with the axis A1 at the center. A diameter B20 of the joining surface 63 in a direction orthogonal to the axis A1 is greater than the diameter B1 of the introduction surface 19 and the diameter B2 of the second reflective surface 17. The outer peripheral surface 64 has a cylindrical shape with the axis A1 at the center. A diameter of the outer peripheral surface 64 in a direction orthogonal to the axis A1 is equal to the diameter B20 of the joining surface 63, and is constant in the up-down direction. The diameter of the projecting portion 62, that is, the diameter of the outer peripheral surface 64, is less than the diameter B6 of the first region 27.

The introduction portion 21 is joined to the projecting end of the projecting portion 62. The introduction portion 21 and the projecting portion 62 are fixed to each other with an adhesive (not illustrated). In the joining section 61, the introduction surface 19 and the joining surface 63 face each other. A medium that transmits the ultrasonic wave (not illustrated) is provided between the introduction surface 19 and the joining surface 63. This can prevent a hollow space from being formed between the introduction surface 19 and the joining surface 63. As in the first embodiment, the joining section 61 is disposed in the region on an inner peripheral side of the first region 27.

As described above, in the present embodiment, as in the first embodiment, the waveguide 13 is a member separate from the ultrasonic wave converging unit 12, and is joined to the ultrasonic wave converging unit 12 in the joining section 61. Therefore, the waveguide 13 can be changed in accordance with the application while using the ultrasonic wave generation source 11 and the ultrasonic wave converging unit 12 in common. In addition, as in the first embodiment, the joining section 61 in which the waveguide 13 and the ultrasonic wave converging unit 12 are joined does not overlap the propagation region through which the ultrasonic wave generated by the ultrasonic wave generation source 11 travels toward the first reflective surface 16. Therefore, the joining section 61 can be prevented from obstructing the propagation of the ultrasonic wave generated by the ultrasonic wave generation source 11.

In addition, the ultrasonic wave converging unit 12 includes the projecting portion 62 that projects upward (away from the second reflective surface 17) from the first reflective surface 16, and the waveguide 13 is joined to the projecting end of the projecting portion 62. According to this structure, the joining surface 63 at which the waveguide 13 is joined to the ultrasonic wave converging unit 12 can be easily formed in a flat shape. Therefore, the ultrasonic characteristics can be improved.

### Fifth Embodiment

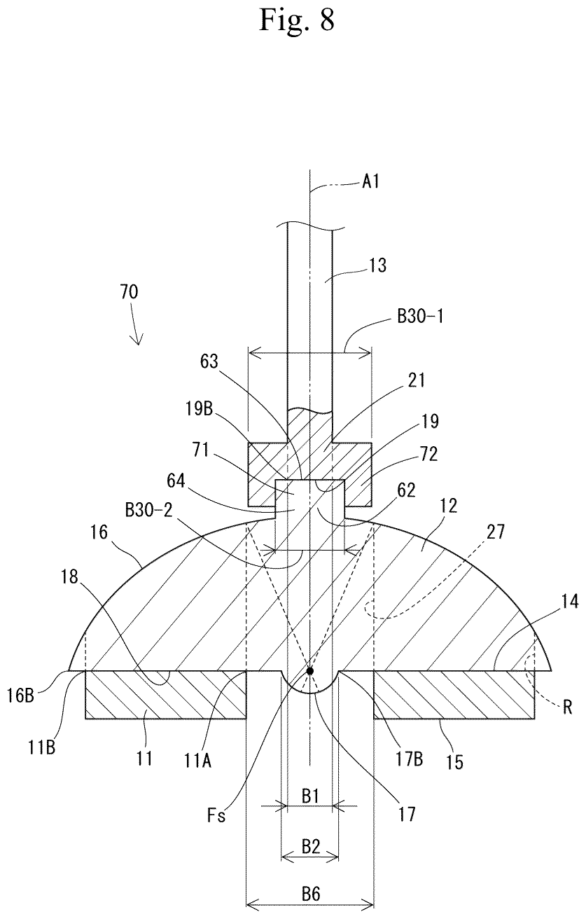

An ultrasonic generator 70 according to a fifth embodiment of the present invention will now be described with reference to FIG. 8. The ultrasonic generator 70 according to the present embodiment differs from the ultrasonic generator of the fourth embodiment in that the introduction portion 21 includes a tubular portion 72. Structures similar to those in the fourth embodiment are denoted by the same reference signs, and description thereof is omitted.

As in the fourth embodiment, the ultrasonic generator 70 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the fourth embodiment, the waveguide 13 is a member separate from the ultrasonic wave converging unit 12, and is joined to the ultrasonic wave converging unit 12 in a joining section 71.

As in the fourth embodiment, the joining section 71 includes the projecting portion 62 that projects upward from the first reflective surface 16, and the introduction portion 21 is joined to the projecting end of the projecting portion 62. As in the fourth embodiment, the projecting portion 62 has the joining surface 63 and the outer peripheral surface 64. A diameter B30-2 of the joining surface 63 in a direction orthogonal to the axis A1 is greater than the diameter B1 of the introduction surface 19 and the diameter B2 of the second reflective surface 17. The diameter of the outer peripheral surface 64 in a direction orthogonal to the axis A1 is equal to the diameter B30-2 of the joining surface 63, and is constant in the up-down direction. The diameter of the projecting portion 62, that is, the diameter of the outer peripheral surface 64, is less than the diameter B6 of the first region 27.

The tubular portion 72 projects downward (toward the first reflective surface 16) from the outer peripheral edge 19B of the introduction surface 19. The tubular portion 72 is integrated with the waveguide 13. The tubular portion 72 has a cylindrical shape with the axis A1 at the center. An outer diameter B30-1 of the tubular portion 72 in a direction orthogonal to the axis A1 is constant in the up-down direction. The tubular portion 72 is fitted to the outer periphery of the projecting portion 62. The outer diameter B30-1 of the tubular portion 72 is greater than the diameter B30-2 of the joining surface 63. As in the fourth embodiment, the joining section 71 is disposed in the region on an inner peripheral side of the first region 27. The outer diameter B30-1 of the tubular portion 72 is less than the diameter B6 of the first region 27.

As described above, in the present embodiment, as in the fourth embodiment, the waveguide 13 is a member separate from the ultrasonic wave converging unit 12, and is joined to the ultrasonic wave converging unit 12 in the joining section 71. Therefore, the waveguide 13 can be changed in accordance with the application while using the ultrasonic wave generation source 11 and the ultrasonic wave converging unit 12 in common. In addition, as in the fourth embodiment, the ultrasonic wave converging unit 12 includes the projecting portion 62 that projects from the first reflective surface 16 in a direction away from the second reflective surface 17, and the waveguide 13 is joined to the projecting end of the projecting portion 62. According to this structure, the joining surface 63 which is joined to the waveguide 13 can be easily formed in a flat shape. Therefore, the ultrasonic characteristics can be improved.

In addition, the introduction portion 21 includes the tubular portion 72 projecting toward the first reflective surface 16, and the tubular portion 72 is fitted to the outer periphery of the projecting portion 62. According to this structure, by fitting the tubular portion 72 to the outer periphery of the projecting portion 62, the joined state of the projecting portion 62 and the introduction portion 21 can be retained. Therefore, the joining strength between the waveguide 13 and the ultrasonic wave converging unit 12 can be increased without using another part.

### Sixth Embodiment

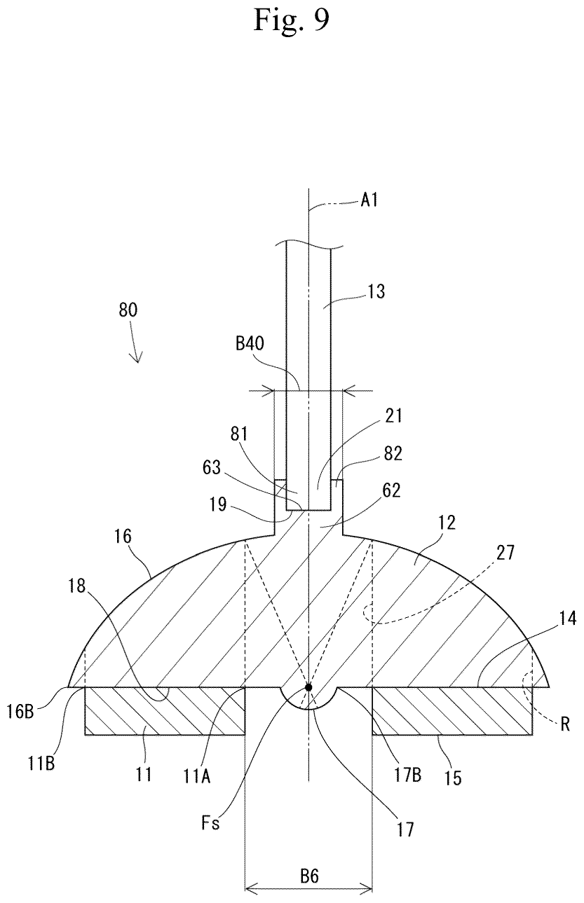

An ultrasonic generator 80 according to a sixth embodiment of the present invention will now be described with reference to FIG. 9. The ultrasonic generator 80 according to the present embodiment differs from the ultrasonic generator of the fourth embodiment in that the projecting portion 62 includes a tubular portion 82. Structures similar to those in the fourth embodiment are denoted by the same reference signs, and description thereof is omitted.

As in the fourth embodiment, the ultrasonic generator 80 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the fourth embodiment, the waveguide 13 is a member separate from the ultrasonic wave converging unit 12, and is joined to the ultrasonic wave converging unit 12 in a joining section 81.

As in the fourth embodiment, the joining section 81 includes the projecting portion 62 that projects upward from the first reflective surface 16, and the introduction portion 21 is joined to the projecting end of the projecting portion 62. The tubular portion 82 projects upward from the outer peripheral edge of the projecting portion 62. The tubular portion 82 is integrated with the projecting portion 62. The tubular portion 82 has a cylindrical shape with the axis A1 at the center. An outer diameter B40 of the tubular portion 82 in a direction orthogonal to the axis A1 is constant in the up-down direction. The tubular portion 82 is fitted to the outer periphery of the introduction portion 21. As in the fourth embodiment, the joining section 81 is disposed in the region on an inner peripheral side of the first region 27. The outer diameter B40 of the tubular portion 82 is less than the diameter B6 of the first region 27.

As described above, in the present embodiment, as in the fourth embodiment, the waveguide 13 is a member separate from the ultrasonic wave converging unit 12, and is joined to the ultrasonic wave converging unit 12 in the joining section 81. Therefore, the waveguide 13 can be changed in accordance with the application while using the ultrasonic wave generation source 11 and the ultrasonic wave converging unit 12 in common.

In addition, the projecting portion 62 includes the tubular portion 82 projecting upward, and the tubular portion 82 is fitted to the outer periphery of the introduction portion 21. According to this structure, by fitting the tubular portion 82 to the outer periphery of the introduction portion 21, the joined state of the projecting portion 62 and the introduction portion 21 can be retained. Therefore, the joining strength between the waveguide 13 and the ultrasonic wave converging unit 12 can be increased without using another part.

### Seventh Embodiment

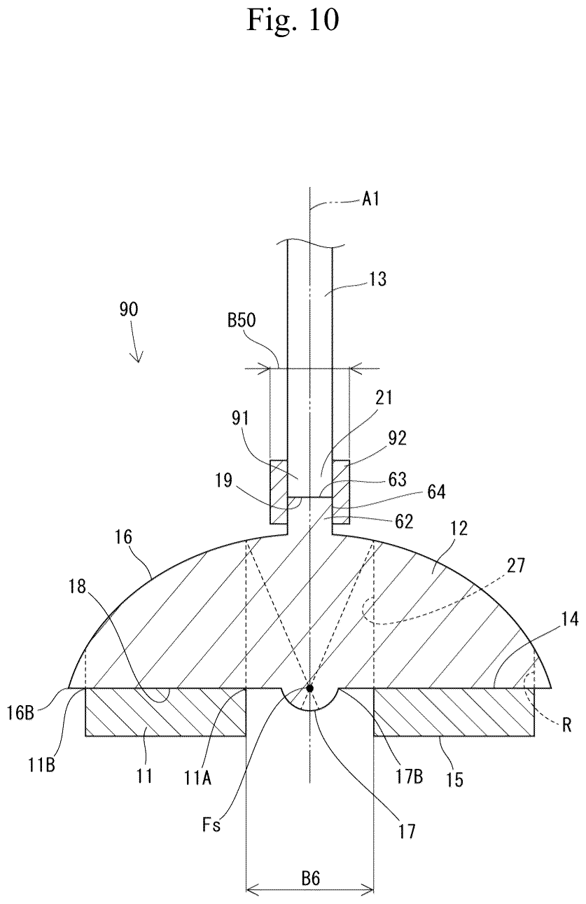

An ultrasonic generator 90 according to a seventh embodiment of the present invention will now be described with reference to FIG. 10. The ultrasonic generator 90 according to the present embodiment differs from the ultrasonic generator of the fourth embodiment in that a joining section 91 includes a holding member 92. Structures similar to those in the fourth embodiment are denoted by the same reference signs, and description thereof is omitted.

As in the fourth embodiment, the ultrasonic generator 90 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12. As in the fourth embodiment, the waveguide 13 is a member separate from the ultrasonic wave converging unit 12, and is joined to the ultrasonic wave converging unit 12 in the joining section 91.

As in the fourth embodiment, the joining section 91 includes the projecting portion 62 that projects upward from the first reflective surface 16, and the introduction portion 21 is joined to the projecting end of the projecting portion 62.

The holding member 92 is a member separate from the ultrasonic wave converging unit 12 and the waveguide 13. The holding member 92 is fitted to the outer peripheries of the projecting portion 62 and the introduction portion 21. The holding member 92 has a cylindrical shape. The holding member 92 is fitted to the outer periphery of the introduction portion 21 and the outer periphery of the projecting portion 62. In a state where the holding member 92 is fitted to the introduction portion 21 and the projecting portion 62, the introduction surface 19 and the joining surface 63 are disposed at the middle of the holding member 92 in the axial direction. In a state where the introduction surface 19 and the joining surface 63 abut against each other, the holding member 92 extends from the outer peripheral surface of the introduction portion 21 to the outer peripheral surface 64 of the projecting portion 62. The holding member 92 is separated upward from the first reflective surface 16. As in the fourth embodiment, the joining section 91 is disposed in the region on an inner peripheral side of the first region 27. In a state where the holding member 92 is fixed to the joining section 91, an outer diameter B50 of the holding member 92 in a direction orthogonal to the axis A1 is less than the diameter B6 of the first region 27.

As described above, in the present embodiment, as in the fourth embodiment, the waveguide 13 is a member separate from the ultrasonic wave converging unit 12, and is joined to the ultrasonic wave converging unit 12 in the joining section 91. Therefore, the waveguide 13 can be changed in accordance with the application while using the ultrasonic wave generation source 11 and the ultrasonic wave converging unit 12 in common. In addition, as in the fourth embodiment, the ultrasonic wave converging unit 12 includes the projecting portion 62 that projects from the first reflective surface 16 in a direction away from the second reflective surface 17, and the waveguide 13 is joined to the projecting end of the projecting portion 62. According to this structure, the joining surface 63 which is joined to the waveguide 13 can be easily formed in a flat shape. Therefore, the ultrasonic characteristics can be improved.

In addition, the ultrasonic generator 90 includes the tubular holding member 92 that extends from the outer peripheral surface of the introduction portion 21 to the outer peripheral surface 64 of the projecting portion 62 in a state where the waveguide 13 and the projecting end of the projecting portion 62 abut against each other. According to this structure, the joined state of the projecting portion 62 and the introduction portion 21 can be retained by the holding member 92. Therefore, the joining strength between the waveguide 13 and the ultrasonic wave converging unit 12 can be increased.

### Eighth Embodiment

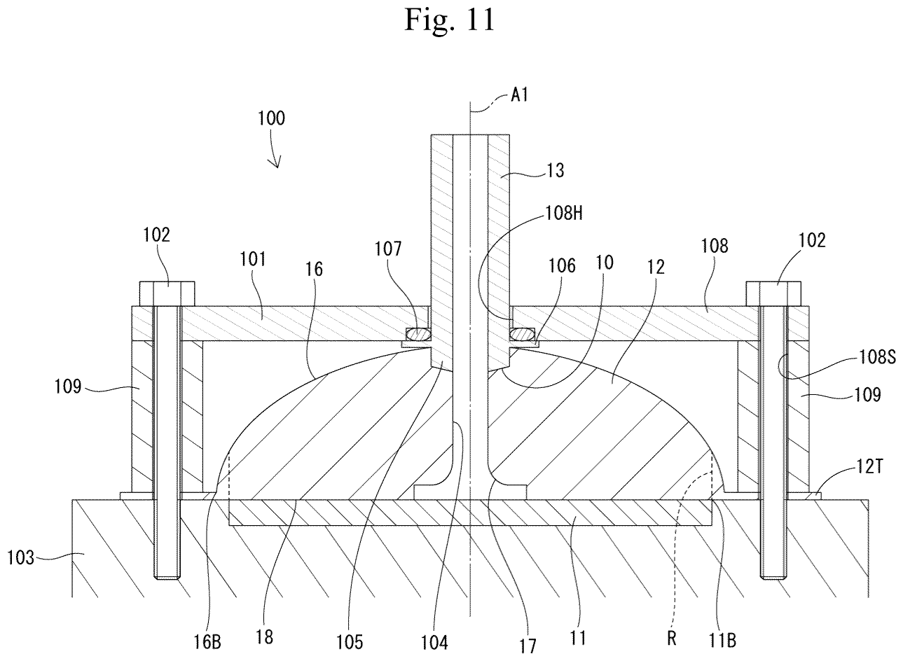

An ultrasonic generator 100 according to an eighth embodiment of the present invention will now be described with reference to FIG. 11. The ultrasonic generator 100 according to the present embodiment mainly differs from the ultrasonic generator of the first embodiment in that a fixing member 101 that fixes the waveguide 13 is provided. Structures similar to those in the first embodiment are denoted by the same reference signs, and description thereof is omitted.

As in the first embodiment, the ultrasonic generator 100 according to the present embodiment includes the ultrasonic wave generation source 11 that generates an ultrasonic wave, the ultrasonic wave converging unit 12 that converges the ultrasonic wave generated by the ultrasonic wave generation source 11, and the waveguide 13 that transmits the ultrasonic wave converged by the ultrasonic wave converging unit 12.

The ultrasonic wave generation source 11 has a circular plate shape. The ultrasonic wave generation source 11 closes a lower end of a through hole 104 formed in the ultrasonic wave converging unit 12. The through hole 104 communicates with an internal space of the waveguide 13. The second reflective surface 17 is continued to an inner peripheral surface that forms the through hole 104. The second reflective surface 17 is formed above the adhesion surface 18. An inner peripheral edge of the second reflective surface 17 is positioned above an outer peripheral edge of the second reflective surface 17. The second reflective surface 17 is curved such that the diameter thereof increases toward the lower side.

The ultrasonic wave converging unit 12 includes a flange portion 12T. The flange portion 12T projects outward from the lower end of the ultrasonic wave converging unit 12. The ultrasonic wave generation source 11 and the ultrasonic wave converging unit 12 are connected to a base portion 103.

As in the first embodiment, the waveguide 13 is a member separate from the ultrasonic wave converging unit 12, and is joined to the ultrasonic wave converging unit 12 in a joining section 105. As in the first embodiment, the joining section 105 is disposed in a region on an inner peripheral side of a region R obtained by extending the outer peripheral edge 11B of the ultrasonic wave generation source 11 in the facing direction in which the ultrasonic wave generation source 11 and the first reflective surface 16 face each other.

The waveguide 13 has a tubular shape extending in the up-down direction. The waveguide 13 includes a flange portion 106. The flange portion 106 is provided on a lower end portion of the waveguide 13, and has an annular shape protruding from the entire circumference of the waveguide 13. The flange portion 106 extends along an upper surface of the first reflective surface 16.

The fixing member 101 is a member separate from the ultrasonic wave generation source 11, the ultrasonic wave converging unit 12, and the waveguide 13. The fixing member 101 includes a pressing member 108, a ring member 107, spacer members 109, and fastening members 102. The pressing member 108 has a circular plate shape. The pressing member 108 has an opening 108H through which the waveguide 13 extends in the up-down direction.

The ring member 107 is formed of an elastic member. The ring member 107 may be made of, for example, acrylonitrile-butadiene rubber (NBR). The ring member 107 is attached to the lower surface of the pressing member 108. The ring member 107 surrounds the opening 108H. The ring member 107 is sandwiched between the pressing member 108 and the flange portion 106. The ring member 107 is in close contact with the pressing member 108 and the flange portion 106.

Four spacer members 109 are provided. The four spacer members 109 are arranged along the outer peripheral edge of the pressing member 108 at equal intervals in the circumferential direction. Each spacer member 109 is disposed between the flange portion 12T and the pressing member 108. Each spacer member 109 has a tubular shape extending in the up-down direction. The lower end of each spacer member 109 is placed on the upper surface of the flange portion 12T. The upper end of each spacer member 109 is pressed by the pressing member 108.

The fastening members 102 are, for example, bolts. The fastening member 102 passes through an insertion hole 108S formed in an outer peripheral edge portion of the pressing member 108 and in an internal space of the spacer member 109, and is fastened to the base portion 103. Thus, the flange portion 106 of the waveguide 13 is pressed against the first reflective surface 16.

As described above, in the present embodiment, as in the first embodiment, the waveguide 13 is a member separate from the ultrasonic wave converging unit 12, and is joined to the ultrasonic wave converging unit 12 in the joining section 105. Therefore, the waveguide 13 can be changed in accordance with the application while using the ultrasonic wave generation source 11 and the ultrasonic wave converging unit 12 in common.

In addition, the ultrasonic generator 100 includes the fixing member 101 that fixes the waveguide 13. According to this structure, the joined state of the waveguide 13 and the ultrasonic wave converging unit 12 can be retained by the fixing member 101. Therefore, the joining strength between the waveguide 13 and the ultrasonic wave converging unit 12 can be increased.

### OTHER EMBODIMENTS

The present invention is not limited to the above description and the embodiments described above with reference to the drawings. The following embodiments, for example, are also included in the technical scope of the present invention.

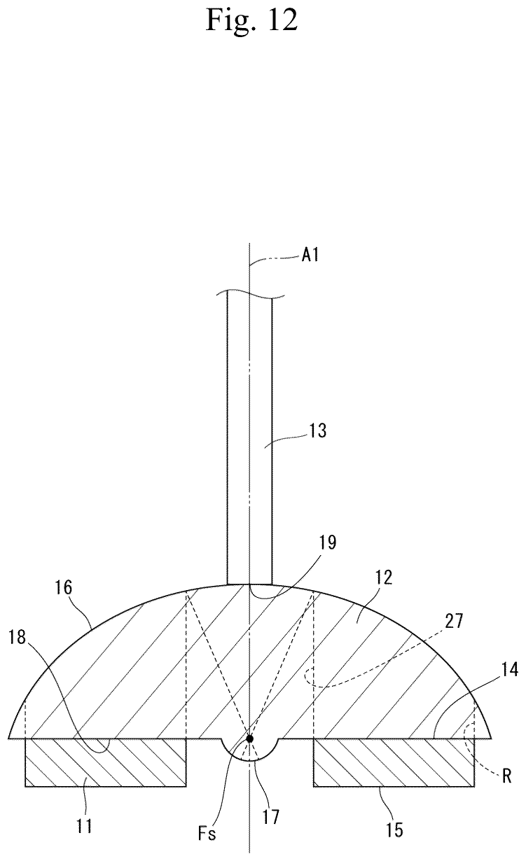

(1) In the above-described embodiments, the first reflective surface 16 has the recess 23 or the projecting portion 62. However, the structure is not limited to this, but as illustrated in FIG. 12, the waveguide 13 may be joined to the first reflective surface 16. The waveguide 13 is joined to a central portion of the first reflective surface 16. The central portion of the first reflective surface 16 may be a part of a parabolic surface. The introduction surface 19 of the waveguide 13 may be directly joined to the first reflective surface 16. According to this structure, the waveguide 13 and the ultrasonic wave converging unit 12 can be joined together without forming a recess or a projecting portion on the ultrasonic wave converging unit 12.

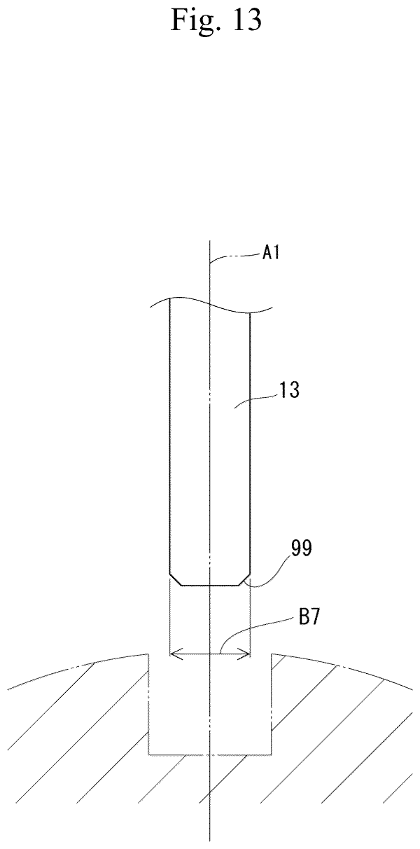

(2) In the above-described embodiments, the lower end of the waveguide 13 has a right-angled corner. However, the structure is not limited to this, but as illustrated in FIG. 13, the waveguide 13 may have a lower end corner with a chamfered portion (for example, tapered, curved, or fillet portion) 99. The chamfered portion 99 is preferably about 10 percent or less of a diameter B7 of the waveguide 13 in a direction orthogonal to the axis A1 so that the propagation of the plane wave is not affected.

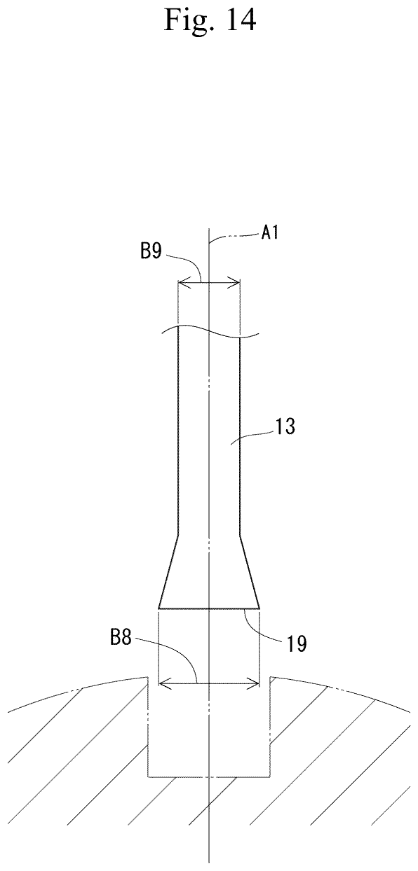

(3) In the above-described embodiments, the lower end of the waveguide 13 has a right-angled corner. However, the structure is not limited to this, but as illustrated in FIG. 14, the waveguide 13 may be shaped such that a lower end portion thereof extends outward toward the introduction surface 19. In this case, a diameter B8 of the introduction surface 19 in a direction orthogonal to the axis A1 can be made greater than a diameter B9 of other portions of the waveguide 13 in a direction orthogonal to the axis A1.

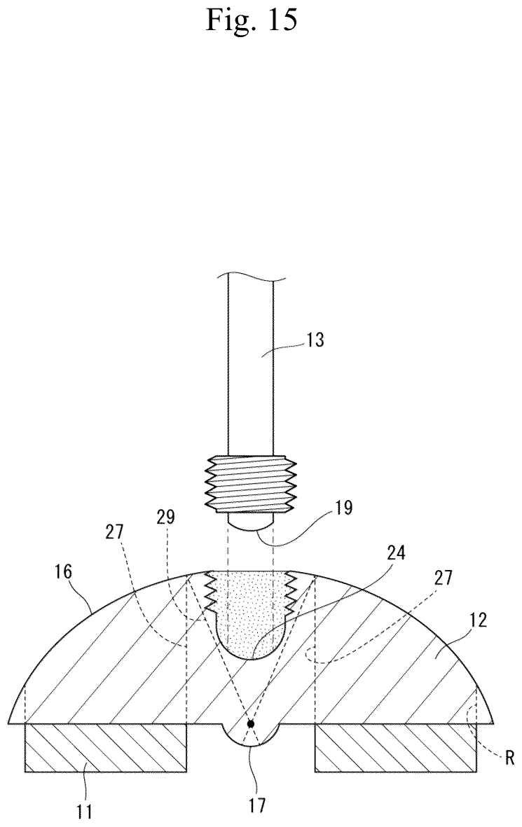

(4) In the above-described embodiments, the introduction surface 19 and the joining surface 24 are flat surfaces. However, the structure is not limited to this, but as illustrated in FIG. 15, the introduction surface 19 and the joining surface 24 may be curved surfaces. In this case, the introduction surface 19 and the joining surface 24 preferably have the same curved shape. Also, preferably, the introduction surface 19 and the joining surface 24 have small curvatures and are gently curved.

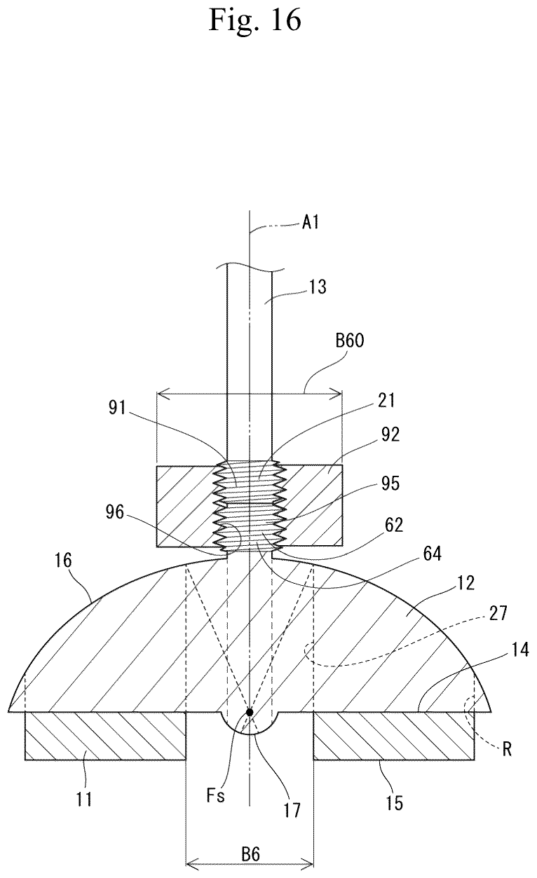

(5) In the above-described seventh embodiment, the joining section 91 includes the holding member 92. In addition, as illustrated in FIG. 16, the holding member 92 may have a screwing structure 95. Helical grooves are formed on the outer peripheral surface of the introduction portion 21, the outer peripheral surface 64 of the projecting portion 62, and an inner peripheral surface 96 of the holding member 92. The grooves in the introduction portion 21 and the projecting portion 62 are formed continuously. Only one of the introduction portion 21 and the projecting portion 62 may have the helical groove. An outer diameter B60 of the holding member 92 in a direction orthogonal to the axis A1 may be greater than the diameter B6 of the first region 27.

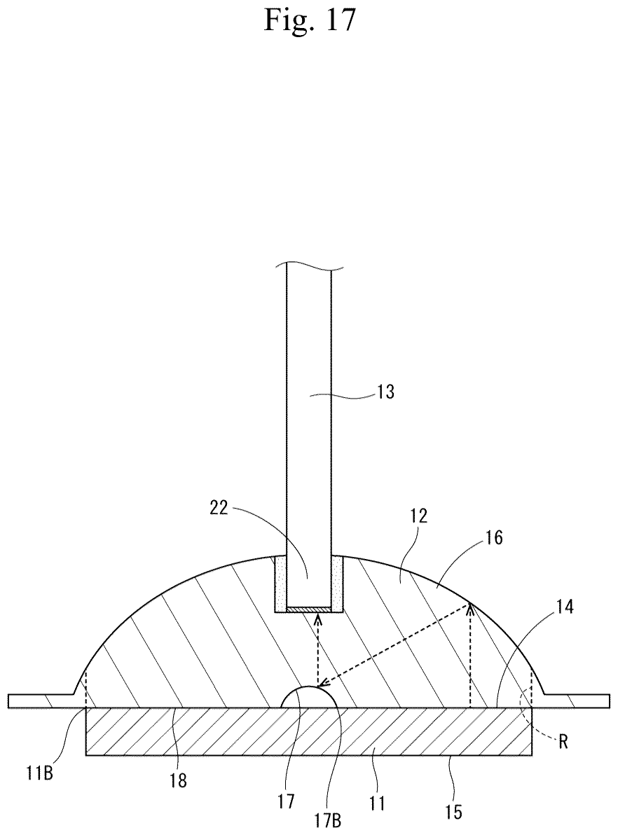

(6) In the above-described first to seventh embodiments, the second reflective surface 17 projects downward beyond the adhesion surface 18, and the ultrasonic wave generation source 11 is shaped to surround the second reflective surface 17. However, the structure is not limited to this, but as illustrated in FIG. 17, the second reflective surface 17 may be recessed upward from the adhesion surface 18. In this case, a central portion of the second reflective surface 17 is positioned above the outer peripheral edge 17B of the second reflective surface 17. Also in this case, the ultrasonic wave generated by the ultrasonic wave generation source 11 is reflected by the first reflective surface 16 and the second reflective surface 17 as shown by the dotted line arrows in FIG. 17, and is introduced into the waveguide 13 as a plane wave.

(7) In the above-described embodiments, the first reflective surface 16 and the second reflective surface 17 are parabolic surfaces. However, the structure is not limited to this, but one or both of the first reflective surface and the second reflective surface may have shapes that are not exactly parabolic as long as they can be regarded as being approximately parabolic. In other words, one or both of the first reflective surface and the second reflective surface may be any surfaces that are curved such that the ultrasonic wave generated by the ultrasonic wave generation source is reflected by the first reflective surface and the second reflective surface and reaches the waveguide. The first reflective surface and the second reflective surface may be composed of many small flat surfaces.

(8) In the above-described embodiments, the ultrasonic wave generation source 11 is a piezo-electric element made of a piezo-electric ceramic material. However, the structure is not limited to this, but the ultrasonic wave generation source may be made of other piezoelectric materials. The ultrasonic wave generation source may be composed of, for example, a multilayer structure made of a piezo-electric ceramic material.

(9) In the above-described embodiments, parallel projection of the entirety of the introduction surface 19 on the second reflective surface 17 is within the second reflective surface 17. However, the structure is not limited to this, but the introduction surface may partially protrude outside the second reflective surface.

(10) In the above-described embodiments, the diameter B4 of the inner peripheral surface 25 of the recess 23 and the diameter B20 of the outer peripheral surface 64 of the projecting portion 62 are constant in the up-down direction. However, the structure is not limited to this, but the diameters of the inner peripheral surface of the recess and the outer peripheral surface of the projecting portion may increase or decrease in the up-down direction.

(11) In the above-described embodiments, the joining surface 24 and the introduction surface 19 have circular shapes. However, the structure is not limited to this, but the joining surface and the introduction surface may have, for example, substantially elliptical shapes or substantially rectangular shapes.

(12) In the above-described embodiments, the waveguide 13 and the ultrasonic wave converging unit 12 may be fixed by applying pressure, for example, by press-fitting.

(13) In the above-described embodiments, the waveguide 13 and the ultrasonic wave converging unit 12 are both solid. However, the waveguide and the ultrasonic wave converging unit are not necessarily solid, and may have, for example, through holes or closed spaces therein.

(14) In the above-described fifth embodiment, the outer diameter B30-1 of the tubular portion 72 is less than the diameter B6 of the first region 27. However, the structure is not limited to this. The upper limit of the outer diameter of the tubular portion is not particularly limited, and may be greater than the diameter of the first region.

(15) In the above-described seventh embodiment, the outer diameter B50 of the holding member 92 is less than the diameter B6 of the first region 27. However, the structure is not limited to this. The upper limit of the outer diameter of the holding member is not particularly limited, and may be greater than the diameter of the first region.

(16) In the above-described eighth embodiment, four spacer members are provided. However, the structure is not limited to this, but the number of spacer members may be changed as appropriate. One spacer member having an annular shape may be provided.

### REFERENCE SIGNS LIST

Fs focal point
R region
10, 40, 50, 60, 70, 80, 90, 100 ultrasonic generator
11 ultrasonic wave generation source
11A inner peripheral edge of ultrasonic wave generation source
11B outer peripheral edge of ultrasonic wave generation source
12 ultrasonic wave converging unit
13 waveguide
16 first reflective surface
17 second reflective surface
21 introduction portion
22, 41, 51, 61, 71, 81, 91 joining section
23 recess
24 joining surface
25 inner peripheral surface of recess
26 medium that transmits ultrasonic wave
27 first region
28 first imaginary line
29 second region
62 projecting portion
72 tubular portion
92 holding member
101 fixing member

1. An ultrasonic generator comprising:
an ultrasonic wave generation source that generates an ultrasonic wave;
an ultrasonic wave converging unit that converges the ultrasonic wave generated by the ultrasonic wave generation source; and
a waveguide that transmits the ultrasonic wave converged by the ultrasonic wave converging unit,
wherein the ultrasonic wave converging unit has a first reflective surface facing the ultrasonic wave generation source and a second reflective surface facing the first reflective surface, the first reflective surface being a curved surface that is convex in a direction away from the ultrasonic wave generation source and reflecting the ultrasonic wave generated by the ultrasonic wave generation source toward the second reflective surface, the second reflective surface reflecting the ultrasonic wave reflected by the first reflective surface toward the waveguide so that the ultrasonic wave is introduced into the waveguide,
wherein the waveguide is a member separate from the ultrasonic wave converging unit and joined to the ultrasonic wave converging unit in a joining section, and
wherein the joining section is disposed in a region on an inner peripheral side of a region obtained by extending an outer peripheral edge of the ultrasonic wave generation source in a facing direction in which the ultrasonic wave generation source and the first reflective surface face each other.

2. The ultrasonic generator according to claim 1, wherein the second reflective surface is a curved surface that is convex in a direction away from the first reflective surface,
wherein the ultrasonic wave generation source is shaped to surround a periphery of the second reflective surface in radial directions orthogonal to the facing direction, and
wherein the joining section is disposed in a region on an inner peripheral side of a first region obtained by extending an inner peripheral edge of the ultrasonic wave generation source in the facing direction.

3. The ultrasonic generator according to claim 1, wherein the waveguide includes an introduction portion,
wherein the joining section includes a recess that is recessed from the first reflective surface toward the second reflective surface,
wherein, when a first imaginary line is an intersecting line between the first region and the first reflective surface and when a second region is a region extending from the first imaginary line to a focal point of the first reflective surface, the recess is disposed in a region on an inner peripheral side of the second region, and
wherein the introduction portion is inserted in the recess.

4. The ultrasonic generator according to claim 3, wherein an outer peripheral surface of the introduction portion and an inner peripheral surface of the recess each have a helical groove, and
wherein the introduction portion is fixed to the recess by screwing.

5. The ultrasonic generator according to claim 1, wherein the ultrasonic wave converging unit includes a projecting portion that projects from the first reflective surface in a direction away from the second reflective surface, and
wherein the waveguide is joined to a projecting end of the projecting portion.

6. The ultrasonic generator according to claim 5, wherein the waveguide includes an introduction portion, and
wherein the ultrasonic generator further comprises a tubular holding member that extends from an outer peripheral surface of the introduction portion to an outer peripheral surface of the projecting portion in a state where the waveguide and the projecting end of the projecting portion abut against each other.

7. The ultrasonic generator according to claim 5, wherein the waveguide includes a tubular portion projecting from an outer peripheral edge of the waveguide toward the first reflective surface, and
wherein the tubular portion is fitted to an outer periphery of the projecting portion.

8. The ultrasonic generator according to claim 1, wherein the waveguide is joined to the first reflective surface.

9. The ultrasonic generator according to claim 1, wherein the ultrasonic wave converging unit has a joining surface that is joined to the waveguide, and
wherein a space between the waveguide and the joining surface is filled with a medium that transmits the ultrasonic wave.

10. The ultrasonic generator according to claim 1, wherein the waveguide and the ultrasonic wave converging unit respectively have an introduction surface and a joining surface that face each other and are joined together, and
wherein the introduction surface and the joining surface are flat surfaces.

11. The ultrasonic generator according to claim 1, further comprising a fixing member that fixes the waveguide.
